(19) United States
(12) Patent Application Publication
(10) Pub. No.: US 2012/0313363 A1
(43) Pub. Date: Dec. 13, 2012

(54) METHOD FOR PRODUCING A SUPPORT COMPRISING AN ELECTRONIC DEVICE

(75) Inventors: Thibaut LeLoarer, Pommier De Beaurepaire (FR); Pascal Marlin, Coulommiers (FR)

(73) Assignee: Arjowiggins Security, Boulogne Billancourt (FR)

(21) Appl. No.: 13/504,656

(22) PCT Filed: Oct. 26, 2010
(86) PCT No.: PCT/IB2010/054834

§ 371 Date: Jun. 6, 2012

(30) Foreign Application Priority Data
Oct. 27, 2009 (FR) 0905176

(51) Int. Cl. B32B 38/06; B23P 11/00; B42D 15/00; D21F 11/00

(52) U.S. Cl. 283/67; 162/140; 156/219; 29/428; 283/74

(57) ABSTRACT

The invention relates to a method for producing a support (100) containing at least one electronic device (50), said support comprising at least one fibrous layer (10) of paper or non-woven material including at least 15% mass of synthetic fibres. Said method comprises a step of introducing the electronic device (50), by means of a grip-release tool, at a site on said fibrous layer (10), that does not contain a cavity, by compressing said fibrous layer (10) such that, once the electronic device (50) has been introduced, it is received in the support (100) without generating any increased thickness.

The subject of the present invention is a method for manufacturing a support that can be cut up into a plurality of support units each integrating at least one electronic device, such as an RFID microcircuit sometimes also called an electronic chip, as well as such a support.

The invention applies for example to RFID documents, in particular to security documents such as banknotes, passports, reservation tokens (vouchers), driver's licenses, interactive playing cards or collectible cards, payment means, in particular payment cards, gift tokens, transport cards, loyalty cards, benefits cards, or else subscription cards.

The invention is more particularly concerned with a support that can be cut up into a plurality of support units ready for graphical customization and that can be inserted between one or two layers of any nature, for example polymer, paper or non-woven, or intended to be introduced into a fibrous mixture of a paper machine for example. Such support units are commonly called “flakes”.

It is desirable, in particular in order to protect and to make it more difficult to detect an electronic security device integrated into a support unit, that this electronic device be compensated in thickness.

It is known through application WO2008/67108 to introduce into a layer of a substrate exhibiting a hollowed out structure an electronic chip by localized compression of said hollowed out structure.

Application US 2007/0141760 teaches to introduce an electronic chip inside a substrate by compressing the latter with the aid of a tool such as a press.

Application US 2008/0291020 teaches to introduce a plurality of flakes into a mixture of paper fibers during the manufacture of an article such as a collectible card.

Known methods for introducing a security device inside a substrate require that a cavity has been previously made in the substrate and/or the employment of a rolling press, which may turn out to be relatively complex to implement, expensive and unsuited to high production rates.

A need exists to manufacture in a relatively simple and inexpensive manner and in large quantity supports integrating one or more electronic devices such as RFID microcircuits, these electronic devices acting for example as security elements.

The object of the invention is to meet this need and it achieves same, according to one of its aspects, by virtue of a method for manufacturing a support integrating at least one electronic device, in particular an RFID microcircuit, this support comprising at least one fibrous layer of paper or of non-woven including at least 15% by mass of synthetic fibers, comprising the steps consisting in:
introducing at least one electronic device by means of at least one pick-and-place tool at a cavity-free site of said fibrous layer, by compressing said fibrous layer, in such a way that on completion of this introduction, the electronic device or devices are received in the support without generating any extra thickness.

The expression “without generating any extra thickness” or “without generating any noticeable extra thickness” should be understood to mean that the thickness of the assembly formed by the support and the electronic device introduced into the support square with the electronic device is between 95 and 105% of that of the support elsewhere.

The electronic device comprises for example a microprocessor and/or an electronic memory, optionally an integrated energy source.

The bulk content of synthetic fibers in the fibrous base may be evaluated for example by a three-dimensional measurement by stereology on a two-dimensional section with a scanning electronic microscope. Several sectional images may be acquired, in the direction of travel of the paper machine (SM) and in the cross direction (ST).

The number of synthetic fibers intercepted by the section for each image is counted for each paper direction, namely Nₛₜ and Nₛₘ. The mean number of synthetic fibers in the paper is calculated by N=(Nₛₜ·Nₛₘ)^{1/2}. The total counted length L of paper is given by the sum of the lengths of the counted images. The number of fibers per linear meter of paper is given by N/ml=N/L. The weight of fibers per m² is calculated by using the linear density (in dtex) and N/ml with the aid of the following formula: WeightFS/m²=w=(Pi/2)*N/ml*Linear density. The fraction of synthetic fibers is obtained by dividing this weight by the basis weight of the fibrous base.

Preferably, the number of images is sufficient to count at least 400 synthetic fibers, so as to reduce the inaccuracy of the process. The measurements are performed under the following climatic conditions: 50% relative humidity and 23° C.

The presence of the synthetic fibers can make it possible to reduce the density of the support by creating more voids, relative to a support which would for example be made entirely of cellulose.

By employing a pick-and-place tool it is possible to adjust the location of the deposition of the electronic device as a function of the desired final format. Moreover, employing such a pick-and-place tool allows a rate of up to for example 10 000 depositions of electronic devices per hour, allowing the manufacturer to react speedily to a client's requirement.

The introduction of the electronic device or devices into the support according to the method according to the invention may be implemented without any prior step consisting in forming a cavity in the support to receive each electronic device and/or without any step consisting in placing the support under a rolling press so that the electronic device or devices are held in the support without generating any extra thickness in the latter and/or without any step consisting in bringing the electronic device or devices into contact with the fibrous layer during formation, by means of a support of elongate shape such as a strip.

The electronic device can comprise a microcircuit. It may be a contactless communication integrated microcircuit, a microcircuit with integrated antenna on a chip or a resonant microcircuit, a microcircuit with communication by electromagnetic waves, and a transponder, for example a photo-activatable micro-transponder, in particular activated by a laser beam.

The microcircuit is for example optionally programmable. The microcircuit may be read-only or read/write.

The support is for example intended to be cut up into a plurality of support units of relatively small format, such as flakes, each support unit comprising an electronic device.

When the electronic device comprises a microcircuit with integrated antenna on a chip, this integrated antenna may be the sole antenna of a support unit or may be coupled to an amplification antenna, also called a booster antenna, integrated into the support unit. The presence of such a booster antenna can make it possible to increase the range of detection of the chip, for example by a factor of 100. Furthermore, such a booster antenna can afford a means for customizing the support.

As a variant, the electronic device may be antenna-less and configured so as to be connected to an antenna of the support unit, for example by soldering, or to an antenna of the document with which the support unit is integrated.

The antenna may be wire-based or other, for example silk-screen printed.

The support can comprise at least one layer of an adhesive covering the fibrous layer and defining, if appropriate, a recto face of the support. The introduction of electronic device(s) into the support can be performed with the aid of the pick-and-place tool through the adhesive layer.

The adhesive layer may be thermofusible or comprise a pressure-sensitive adhesive.

The support can comprise at least one intermediate bonding layer between the fibrous layer and the adhesive layer. The introduction of electronic device(s) can be performed with the aid of the pick-and-place tool through this intermediate layer.

At least one, in particular each, electronic device can penetrate into the fibrous layer over at least 20%, for example 30%, or indeed 50%, or 70%, of the thickness of said fibrous layer.

As a variant, at least one, in particular each, electronic device is not received in the thickness of the fibrous layer, being received only in the intermediate layer and/or the adhesive layer.

The support can comprise a printing layer devoid of synthetic fibers and/or of cellulose fibers and defining, if appropriate, its verso face.

The synthetic fibers of the fibrous layer can comprise a mixture of at least two thermoplastic materials, for example of polyamide and of polyester. Employing polyamide makes it possible for example to impart flexibility and elasticity to the fibrous layer and employing polyester can make it possible to afford said fibrous layer dimensional stability as a function of humidity and temperature.

The mass of polyamide is for example between 0.9 and 1.1 times the mass of polyester in the support.

The fibrous layer can comprise a bulk latex whose glass transition temperature measured by DSC (Differential Scanning calorimetry) lies between −40° C. and +60° C., in particular between −25° C. and +50° C.

The fibrous layer can exhibit a compressibility of between 10 and 40%, in particular between 10 and 30%, this compressibility being defined by the ZWICK standard and corresponding to the difference in thickness between an unstressed configuration and a stressed configuration of the fibrous layer.

The pick-and-place tool may be configured to heat the support and/or the electronic device, in particular in the presence of a thermofusible adhesive layer that must be crossed during the insertion of the electronic device.

The heating can be performed at a temperature of greater than or equal to 80° C.

The method can comprise the step according to which the off-line or in-line coating of a thermosealing varnish on the one at least of the face of the adhesive layer opposite from the fibrous layer and of the face of the printing layer opposite from the fibrous layer is undertaken.

A first varnish layer is for example coated on the adhesive layer, in such a way that the adhesive layer is sandwiched between the first varnish layer on the one hand and the fibrous layer or the intermediate layer on the other hand, this first varnish layer defining the recto face of the support. Such a varnish layer can improve the protection of the electronic device introduced into the support.

A second varnish layer is for example coated on the printing layer, in such a way that the latter is sandwiched between the fibrous layer and the second varnish layer, this second varnish layer defining the verso face of the support.

When the support units cut from the support are intended to be integrated into a, for example papery, fibrous article, the employing of such a varnish can favor the bonding of support units in the article.

As a variant, only the first varnish layer is coated on the adhesive layer through which the electronic device or devices are introduced, and a printing is performed on the printing layer. This printing corresponds for example to an ink patch invisible to the naked eye and visible under UV light. This printing may be performed square with the electronic device and constitute a benchmark during a subsequent step of cutting the support.

The varnish contains for example a fluorescent ink and can exhibit adhesive properties.

This varnish coating step is in particular favored by the introduction without generating extra thickness of electronic device(s) into the support.

During a subsequent step, the support, with or without varnish layer(s), may be cut, for example by laser, to produce the support units. Each support unit can contain one or more electronic devices. Alternatively, the support may be cut by two successive coaxial cylinders, each of the cylinders carrying a complementary cutting pattern which criss-crosses with the other pattern so as to constitute a resulting pattern which will form the support unit, as described in patent EP1718441.

The surface area of a support unit is advantageously greater than that of the electronic device, the latter being for example situated entirely inside the area of the support unit. Advantageously the cutting of the support units is performed with the benchmark so that the electronic device is disposed in a benchmarked manner with respect to the form of the support unit.

The support units may be cut so as to exhibit a decorative form, for example a geometric pattern such as an ellipse, a circle, a polygon, a rectangle, a square, a star. As a variant, the support units can define a writing symbol, in particular an alphanumeric character, or an image of a recognizable object, such as an animal, a plant, a logo or a personage.

When a printing has been deposited on the printing layer square with the electronic device, the support unit may be cut according to the exterior contour of the pattern or of the patch deposited.

The support units can have a relatively small format, being for example flakes.

Each support unit exhibits for example a larger dimension of between 0.5 and 5 millimeters.

The subject of the invention is also, according to another of its aspects, a method for manufacturing a security document comprising a fibrous substrate, in which:
the recto face of at least one support unit such as defined hereinabove is appended to a face of a substrate of the article or,
at least one support unit such as defined hereinabove is introduced into a fibrous material dispersion intended to form the fibrous substrate of the security document in a paper machine.

The quantity of support units introduced into the mixture of fibers in the machine is for example calculated in such a way that said mixture is homogeneous in terms of the number of support units, allowing the probability of having the same number of support units per article to be large.

At least one electronic device of the substrate may be out of use, having for example been damaged during the cutting of the support units.

The article is for example a document and the invention can make it possible to introduce one or more electronic devices inside a, for example paper, document without performing any benchmarking on the document.

Moreover, with respect to the introduction of an electronic device into a machine for manufacturing a fibrous substrate, according to the invention the electronic devices introduced have been previously integrated into the support, the latter comprising layers protecting the electronic device.

In a particular embodiment of the invention, the support units each comprise a through hole or an interior perforation and an electronic device introduced in the manner described hereinabove and disposed on the support unit but outside of the perforation. Such a through hole or such a perforation can make it possible to improve the holding of the support units in the fibrous substrate.

In another particular embodiment of the invention, the support, integrating at least one electronic device and being obtained with the aid of the method defined hereinabove, takes the form of a strip or band and it is introduced into a paper machine in a fibrous material dispersion which is intended to form the fibrous substrate of the security document. Preferably the support integrates several electronic devices which, on account of their introduction in a strip, are disposed in a localized zone of the security document, thereby facilitating in particular the reading of the electronic devices. For example, the security strip thus constituted has a width of between 2 and 60 mm, preferably between 4 and 30 mm and more preferably between 10 and 20 mm.

The article may be a security document such as a passport or a driver's license and the substrate and the support unit can define at least in part the wrapping of this security document.

The subject of the invention is also, according to another of its aspects, a support integrating at least one electronic device, obtained with the aid of the method defined hereinabove.

The subject of the invention is also, according to another of its aspects, a support integrating at least one electronic device, the support comprising:
at least one fibrous layer comprising at least 15% by mass of synthetic fibers,
a layer of an adhesive defining a recto face of the support and,
the electronic device received without extra thickness in the support, engaged in the adhesive layer and in at least one portion of the thickness of the fibrous layer.

The subject of the invention is also, according to another of its aspects, a security document such as a passport, an identity card, a driver's license, an interactive playing card or collectible card, a payment means, in particular a payment card, a gift token or a voucher, a transport card, a loyalty card, a benefits card, a subscription card, manufactured as mentioned hereinabove.

The subject of the invention is also, according to another of its aspects, a fibrous substrate for producing an article, in particular a document such as a security document, said substrate comprising a plurality of support units each comprising at least one electronic device received inside said support unit without generating any extra thickness.

At least one of the electronic devices can contain information specific to it and information pertaining to other electronic devices of the fibrous substrate.

At least one of the electronic devices of the substrate may be out of use.

The support units can exhibit the same characteristics as those obtained on completion of the method for manufacturing the support described hereinabove.

At least one support unit or the fibrous substrate can furthermore comprise at least one so-called “first level” security element detectable to the naked eye in visible light and without the use of a particular apparatus and/or at least one so-called “second level” security element detectable only with the aid of an apparatus such as a lamp emitting in the ultraviolet or the infrared and/or at least one other so-called “third level” security element comprising a tracer capable of generating a specific signal when subjected to a suitable optoelectronic excitation or a chemical or “tagging” marker.

The subject of the invention is also, according to another of its aspects, a method for authenticating and/or for identifying a security document comprising a fibrous substrate comprising a plurality of support units each receiving at least one electronic device without extra thickness, the support units being in particular such as described hereinabove, the document comprising at least one identifier, in particular registered on the document, and a code being assigned to each electronic device of each support unit, in which method:
a code is determined, resulting from the association of the codes of the electronic devices of the security document,
the identifier of the document is read, for example visually or automatically and,
it is determined whether a predefined relation between the identifier of the document and the resulting code is satisfied, so as to identify and/or authenticate the article.

The term “code” should be understood in the broad sense, designating for example either numbers, letters recorded in a memory of a chip or, in the case of a resonant microcircuit, a resonating signal.

The mapping between the code and the identifier corresponds for example to a comparison operation or to a more complex function, a part of the code being for example enciphered or deciphered.

The same code, or several distinct codes, may be associated with several electronic devices of the article and, during the determination, these codes may be read. A global code may be determined, for example by concatenation, on the basis of the codes read, and this global code may be mapped with the identifier of the article. The identifier of the article is for example a number equal to the global code. As a variant, this identifier may be distinct from the global code, ensuring the uniqueness of the authentication.

The article is for example manufactured on the basis of the fibrous substrate hereinabove.

The invention may be better understood on reading the description which follows, of nonlimiting examples of implementation of the latter, and on examining the appended drawing in which:

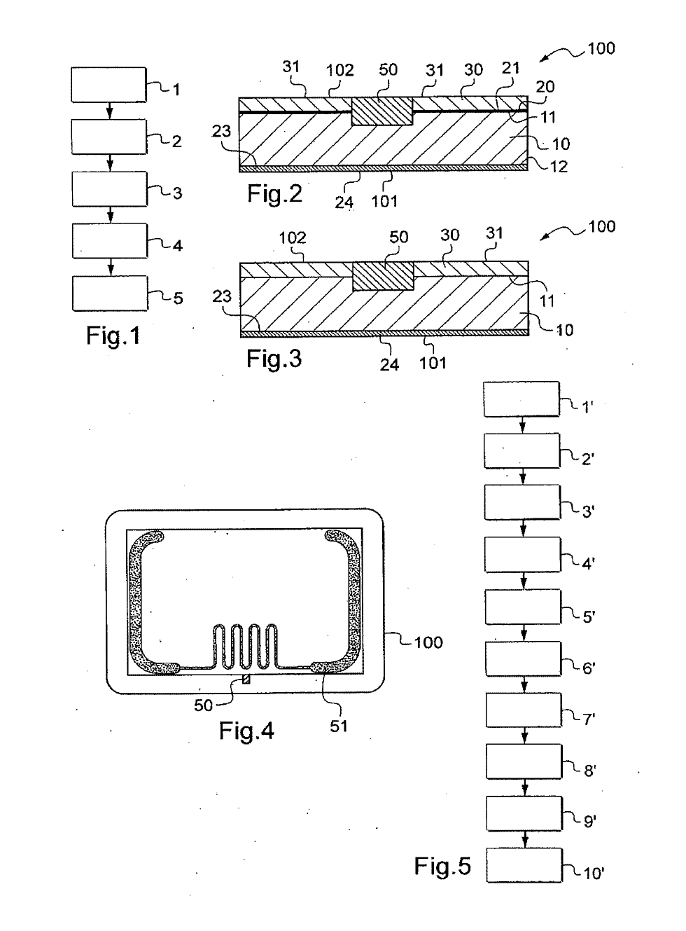

FIG. 1 represents in a schematic manner examples of steps during a manufacturing method according to a first exemplary implementation of the invention,

FIGS. 2 and 3 are sectional views of various examples of supports obtained with the aid of the method according to the invention,

FIG. 4 is a view from above of another exemplary support obtained with the aid of the method according to the invention,

FIG. 5 represents in a schematic manner examples of steps during a manufacturing method according to another exemplary implementation of the invention and,

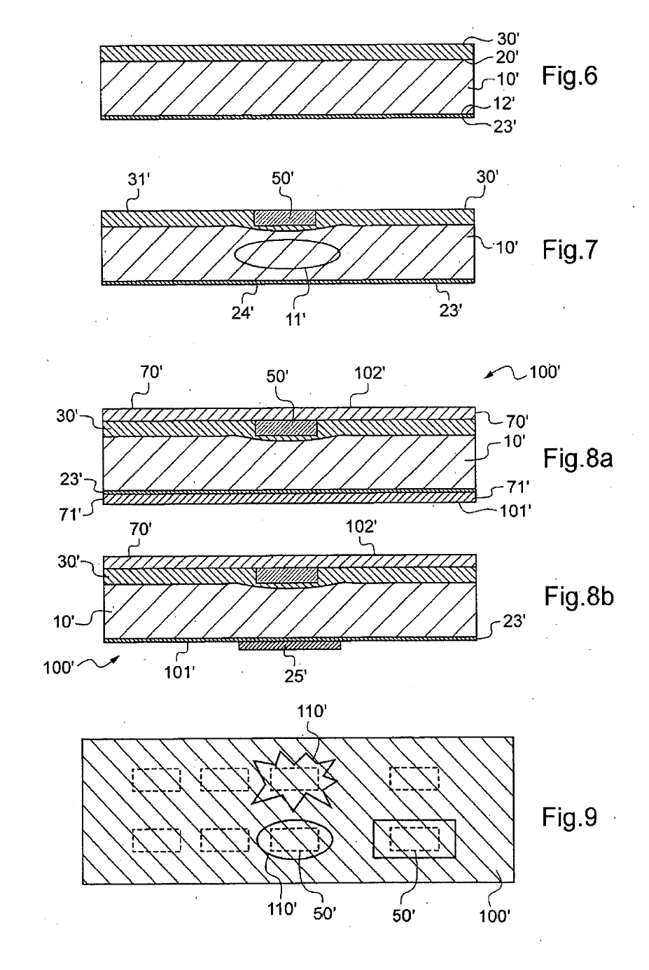

FIGS. 6 to 9 represent examples of supports during the steps of the method represented in FIG. 5.

Steps of a method for manufacturing a support 100 that can be cut into support units, according to a first exemplary implementation of the invention, will be described in a schematic manner with reference to FIGS. 1 and 2.

During a step 1, a fibrous layer 10 is manufactured, for example by the paper route, which includes at least 15% by mass of synthetic fibers. The synthetic fibers comprise for example a mixture of polyamide and polyester in substantially equal proportions. The synthetic fibers have for example a length of at least 3 mm and a diameter of at least 10 μm.

The fibrous layer 10 can comprise cellulose fibers, for example fibers arising from eucalyptus and from pine.

This fibrous layer 10 may be saturated with bulk latex, the latter exhibiting for example a glass transition temperature of between −40° C. and +60° C. and may for example be styrene butadiene in nature.

The fibrous layer 10 can exhibit a compressibility of between 10 and 40%, in particular between 10 and 30%, for example equal to 15%.

The fibrous layer 10 can exhibit a thickness of between 70 and 400 μm.

During a step 2, the in-line coating, for example with the aid of a TWIN™ HSM machine, or the off-line coating, is undertaken on a face 11 of said fibrous layer 10, of a filled intermediate layer 20 allowing bonding between the fibrous layer 10 and an adhesive layer. During this step 2, it is also possible to undertake the in-line or off-line coating of a printing layer 23 devoid of synthetic fibers on the face 12 of the fibrous layer 10 opposite from the face 11 receiving the intermediate layer 20. The intermediate layer 20 contains for example mineral fillers and latex and the quantity coated is for example between 5 and 50 g/m².

The printing layer 23 is advantageously chosen as a function of the type of printing desired for the customization of the final document with which the support 100 is intended to be integrated, this printing being for example a gravure printing, an offset printing, an ink jet printing or else an indigo printing. The printing layer 23 exhibits a face 24 opposite from the fibrous layer which can define the verso face 101 of the support 100.

During a step 3, the in-line coating, for example still with the aid of a TWIN™ HSM machine, or an off-line coating, is undertaken on the face 21 of the intermediate layer 20 of an adhesive layer 30. The latter exhibits a face 31 opposite from the layer 20 which can define the recto face 102 of the support 100.

The adhesive 30 is for example a thermofusible or pressure-sensitive adhesive. The adhesive 30 is for example based on polyurethane or acrylic and the layer 30 can exhibit a thickness of at least 10 micrometers. The deposition of the adhesive layer 30 is in particular between 5 and 25 g/m², in particular about 15 g/m², or indeed 10 g/m². In one example, the adhesive is acrylic and deposited at 15 g/m².

During a step 4, the support is conveyed to the station for depositing the electronic devices 50.

The electronic devices 50 comprise for example microcircuits of the contactless communication chip type. These chips can comprise an integrated antenna, being for example so-called AOB (antenna on board) chips or OCA (on chip antenna) chips. An example of such OCA chips is for example described on the Internet site http://www.fecinc.com.my/mmchip/mm_on_chip_antenna.htm. AOB chips that are most particularly suitable can exhibit a thickness of between 60 and 80 μm, for example 70 μm, and a width of between 30 and 50 μm, for example 40 μm. As a variant, the electronic device 6 comprises a resonant microcircuit, a microcircuit with communication by electromagnetic waves or a micro-transponder reacting to a diffuse light beam. The support 100 may be devoid of any antenna other than that of the microcircuit 50, in particular that integrated into the chip of said microcircuit. As a variant, the support 100 comprises at least one booster antenna 51, as represented in FIG. 4. This booster antenna 51 is for example produced by printing, etching, silk-screen printing or is wire-based.

This booster antenna 51 may be coupled electromagnetically to the antenna integrated into the chip of an electronic device 50 and it can exhibit a decorative form, for example a geometric pattern such as an ellipse, a circle, a polygon, a rectangle, a square, a star. As a variant, the booster antenna 51 can define a writing symbol, in particular an alphanumeric character, or an image of a recognizable object, such as an animal, a plant, a logo or a personage. In the example of FIG. 4, the booster antenna 51 schematically represents a butterfly. The booster antenna 51 may or may not form a loop.

In another variant, not represented, the electronic device 50 comprises a distinct antenna from the chip.

During a step 5, the electronic device 50 is deposited with the aid of a pick-and-place tool, for example such as that marketed by the company DATACON®.

The pick-and-place tool is for example configured to heat the electronic device 50 and/or the support 100, prior to sinking the electronic device 50 into the support 100.

During this step 5, the electronic device 50 is for example extracted by the pick-and-place tool from a wafer comprising a large number of such elements of such devices 50, and is then positioned in an accurate and parametrizable manner on the support intended to accommodate it in its thickness.

When the electronic device 50 is an AOB or OCA chip, the electronic device 50 may be introduced into the support 100 in such a way that the face of the chip 50 carrying the antenna rests inside the support 100 facing the fibrous layer 10.

The electronic device 50 may be sunk through the layer 30 of the support by the pick-and-place tool and lies inside the support 100 by compressing the layers 10 and 20. On completion of this step 5, the electronic device is present in the support 100 without generating any noticeable extra thickness. Square with the electronic device for example the support exhibits the same thickness as elsewhere to within 10 μm.

During a subsequent step 6, the support 100 can be cut into a plurality of support units and at least one of these support units can be used to manufacture an article. Each recto face 102 of a support unit is for example appended to a face of a substrate of a security document such as a passport or a driver's license, so as to define with said substrate in part at least one wrapping of the article.

The support units obtained with the aid of the method described hereinabove can further be used to produce security documents such as identity cards, interactive playing cards or collectible cards, payment means, in particular payment cards, gift tokens, transport cards, loyalty cards, benefits cards, or else subscription cards.

According to a particular exemplary implementation of the invention, the fibrous layer 10 is manufactured by the company ARJOWIGGINS SECURITY with the aid of a flat table machine, this layer 10 comprising 15% of synthetic fibers made of half polyamide and half polyester. The adhesive layer 30 is for example of acrylic type and the printing layer 23 is suited to offset printing. The electronic device 50 is according to this example an MM2 chip marketed by the company FEU®, this chip 50 comprising if appropriate an integrated antenna.

The invention is not limited to the implementation of the set of steps 1 to 5 described hereinabove to produce the support.

In the variant of FIG. 3, the support is devoid of intermediate layer 20, and steps 2 and 3 described hereinabove are replaced with a single step in the course of which a dual-face coating of the adhesive layer 30 and of the printing layer 23 is for example undertaken.

In another variant, the support is devoid of printing layer 23, that is to say its verso face 101 is defined by the face 12 of the fibrous layer, the support 100 possibly being subsequently inserted between two layers of printable paper.

In another variant, a previously manufactured fibrous layer 10 is deployed, when the method is implemented.

A manufacturing method according to a second exemplary implementation of the invention will now be described with reference to FIGS. 5 to 9.

Steps 1′ to 4′ are for example similar to steps 1 to 4 described with reference to FIGS. 1 to 4.

An exemplary multilayer structure obtained on completion of step 3′ has been represented in FIG. 6. The fibrous layer 10′ exhibits for example a compressibility of at least 15%. The intermediate layer 20′ is sandwiched between the fibrous layer 10′ and the adhesive layer 30′ which exhibits for example a thickness of at least 5 μm, in particular about 15 μm.

The structure may or may not comprise a printing layer 23′ deposited on a face 12′ of the fibrous layer 10′. This printing layer is for example filled with one or more pigments visible or invisible under UV light and exhibits for example a thickness of at least 5 μm, being for example equal to 15 μm.

The layers 10′, 20′, 23′ and 30′ are for example deposited in-line on a paper machine.

During a step 5′ represented in FIG. 7, at least one electronic device 50′, which is for example such as described hereinabove, is introduced into the multilayer structure. In contradistinction to the example described with reference to FIGS. 1 to 4, the electronic device 50′ is received only in the thickness of the adhesive layer 30′ and not inside the fibrous layer 10′, the introduction of the electronic device 50′ inducing a compressed zone 11′ of the fibrous layer 10′.

When the electronic device 50′ comprises a chip with integrated antenna, this device 50′ may be introduced inside the adhesive layer 30′ in such a way that the face of the chip carrying the antenna rests facing the fibrous layer 10′. The antenna is thus protected.

As may be noted, on completion of this step 5′, the electronic device 50′ rests in the adhesive layer 30′ without generating any extra thickness since the thickness variation generated by the introduction of the electronic device is compensated by the fibrous layer 10′ square with the electronic device 50′.

In the example illustrated, the method further comprises a step 7′ in which a thermosealing varnish, for example acrylic or polyurethane, is coated on at least one out of the adhesive layer 30′ and the printing layer 23′. This thermosealing varnish may be deposited by in-line coating with the aid of a TWIN™ HSM machine or according to the so-called “air knife” or “Champion coating” processes. As a variant, the varnish is deposited by off-line coating, for example according to the so-called “air knife”, “Champion coating” or “offset” processes.

In the example of FIG. 8a, the support 100′ comprises a first varnish layer 70′ coated on the face 31′ of the adhesive layer 30′ defining the recto face of the structure obtained on completion of step 3′ and a second varnish layer 71′ coated on the face 24′ of the printing layer 23′ defining the verso face of said structure.

The first, respectively second, varnish layer can then define the recto face 102′, respectively verso face 101′, of the support 100′ obtained.

In the example of FIG. 8b, the support 100′ is devoid of second varnish layer 71′, only the adhesive layer 30′ being overlaid with the thermosealing varnish layer 70′. When the printing layer 23′ is not covered by a varnish layer, a pattern or a patch 25′ may be printed on the latter, for example with a security ink. This printing is for example performed with the aid of visible or invisible ink according to the light and square with the electronic device 50′.

A flag for example is printed with color inks square with the electronic device 50′. When viewed from above, the electronic device 50′ may be situated inside the exterior contour of the pattern or of the patch 25′.

During a step 8′, the support 100′ is cut into a plurality of units 110′ of relatively small format such as flakes, each unit comprising at least one electronic device 50′. This cutting is performed for example by laser. When a pattern or a patch 25′ has been deposited in step 7′, this step 8′ may be registered on the print deposited. In this way the electronic device and the pattern 25′ are guaranteed to be situated on the support unit 110′ after the cutting step. In the case where the support is not cut up into flakes, the pattern 25′ may be printed in a manner shifted with respect to the electronic device. For example, the pattern 25′ can constitute a pattern complementary to the electronic device designed to indicate the presence of the electronic device and thus facilitate its reading. The pattern 25′ can for example take an annular form indicating at its center the presence of the electronic device.

As represented in FIG. 9, when viewed from above, the surface area of a unit 110′ is greater than the surface area of the electronic device and the entire electronic device is situated inside the unit 110′. The cutting can exhibit a decorative shape, for example a geometric pattern such as an ellipse, a circle, a polygon, a rectangle, a square, a star. In this case, as a result of the registered cutting, the electronic device is benchmarked with respect to the shape of the support unit. As a variant, the cutting can define a writing symbol or an image of a recognizable object.

In the example illustrated, a support unit 110′ comprises just a single electronic device 50′ but could comprise more.

During a step 9′, the support units 110′ are introduced into paper machine in the dispersion of fibrous material for the manufacture of all or part of articles, for example security documents. The support units may be introduced continuously into the paper machine, that is to say without intermediate storage of the paper fibers. Furthermore, the support units may be projected toward the still wet fibrous substance while travelling past so as to form a continuous strip pattern. As described previously, the support integrating several electronic devices can also be cut into a band and thus introduced into paper machine in the dispersion of fibrous material. The introduction of the strip support units or the introduction of a support integrating several electronic devices in band form involves localized disposition of the electronic devices with respect to the security document thereby facilitating in particular the reading of the electronic devices. During a step 10′ it is possible to deposit, in particular by printing, a booster antenna on the article with which one or more support units are integrated.

The security document comprises for example several electronic devices 50′. Each chip can possess a single number, for example composed of two letters followed by two digits, and a corresponding number is registered on the document. The reading of the document may be authenticated in a unique manner by comparing the number registered on the document with a code resulting for example from the concatenation of the codes of the chips present on said document.

In a variant, the number registered on the document consists of the sum of the codes of the chips.

When the electronic device is a resonant microcircuit, each device 50′ reverts to a single resonant signal detector and final document possesses a global resonant circuit resulting from the sum of all the resonant circuits.

Two examples of articles manufactured with the aid of the method such as described in FIGS. 5 to 9 will now be described.

In the first example, a voucher is manufactured. During step 1′, a fibrous layer is manufactured on flat table, said layer having 15% of synthetic fibers with a thickness of 120 μm and a basis weight of 100 g/m² with deposition on one side of the fibrous layer 10′ of a thermosealing adhesive layer 30′ whose thickness is 15 μm and on the opposite face 12′ of the fibrous layer 10′ of a layer colored white in the visible and colored blue under ultra-violet. This printing layer 23′ exhibits for example a thickness of 5 μm.

During step 5′, at least one chip 50′ is deposited on the upper face 31′ of the adhesive layer 30′ with the aid of a place-and-pick tool, which is for example that marketed by the company DATACON.

During step 7′, a thermosealing varnish layer 70′ and 71′ of thickness 15 μm is coated on the exterior faces of the structure obtained on completion of step 5′ by the so-called “air knife” process. During step 8′, the support units 110′ are cut by laser into a star shape, the electronic device 50′ preferably being situated at the center of the star. As a variant, it may be undertaken, during this step 8′ according to the cutting method disclosed in application EP 1 718 441.

The electronic device 50′ can for example form an integral part of a registration benchmark on the support unit 110′, as described in application WO 2008/015363.

Finally, during step 9′, the support units 110′ are introduced continuously on a flat table paper machine.

According to a second example, the manufacture of a banknote is undertaken. During step 1′, a support layer 10′ with 15% of synthetic fibers, a thickness of 100 μm and a basis weight of 90 g/m² is manufactured on flat table.

A layer of a thermosealing adhesive 30′ of thickness 15 μm is deposited on the upper face of the fibrous layer 10′.

During step 5′, at least one electronic device is deposited on the upper face 31′ of the adhesive layer 30′ with the aid of a pick-and-place tool which is for example marketed by the company DATACON. Prior to step 8′, flags of blue/white/red color are printed as benchmark of the electronic devices 50′ on the printing layer 23′. Finally, during step 9′, the laser cutting of support units 110′ having a printed flag shape is undertaken, the electronic device 50′ of each support unit being situated at the center of the flag. During step 9′, the support units 110′ are introduced into the chest of a cylinder vat paper machine.

An article thus obtained comprises at least one electronic device and can also comprise at least one so-called “first level” security element and/or at least one so-called “second level” security element such as were mentioned hereinabove.

The article can in particular comprise as security elements, inter alia:
dyes and/or luminescent pigments and/or interferential pigments and/or liquid-crystal pigments, in particular in printed form or mixed with at least one constituent layer of the article,
coloring components and/or photochromic or thermochromic pigments, in particular in printed form or mixed with at least one constituent layer of the article,
an ultraviolet absorber (UV), in particular in coated form or mixed with at least one constituent layer of the article,
a light-collecting specific material, for example of the “waveguide” type, for example a luminescent light-collecting material such as polycarbonate-based polymer films marketed by the company BAYER under the name LISA®,
an interferential multilayer film,
a structure with variable optical effects, based on interferential pigments or liquid crystals,
a birefringent or polarizing layer,
a diffraction structure,

an embossed image,
means producing a “moiré pattern effect”, such an effect being able for example to reveal a pattern produced by superposing two security elements on the article, for example by closely spacing lines of two security elements,
a partially reflecting refractive element,
a transparent lenticular grid,
a lens, for example a magnifying glass,
a colored filter,
a security thread incorporated for example into the bulk of at least one constituent layer of the article or as a window, optionally comprising a print printed in positive or in negative, a fluorescence, a metallic, goniochromatic or holographic effect, with or without one or more demetallized parts,
a metallized, goniochromatic or holographic foil,
a layer with variable optical effect, based on interferential pigments or liquid crystals,
a flat security element of relatively small format such as a flake, visible or not visible, in particular luminescent, with or without electronic device,
particles or agglomerates of particles of pigments or dyes of HI-LITE type, visible or not visible, in particular luminescent,
security fibers, in particular metallic, magnetic (with soft and/or hard magnetism), or absorbent, or excitable under ultraviolet, the visible or infrared, and in particular the near infrared (NIR),
an automatically readable security feature having specific and measurable characteristics of luminescence (for example fluorescence, phosphorescence), of absorption of light (for example ultraviolet, visible or infrared), of Raman activity, of magnetism, of microwave interaction, of interaction with X rays or of electrical conductivity.

One or more security elements such as defined above may be present in the article and/or in one or more constituent layers of the article or in one or more security elements incorporated into the article and/or into one or more constituent layers of the article, as for example a thread, a fiber or a flake.

At least one of the constituent layers of the article can also comprise a first-level security element such as a watermark or a pseudo-watermark superimposed at least partially on a translucent region of the article.

The expression “watermark or pseudo-watermark” according to the invention, is understood to mean a drawn image which appears in the thickness of the article.

The watermark or pseudo-watermark may be produced in various ways known to the person skilled in the art.

Accordingly the article can comprise at least one of a fibrous or polymer layer, of a sub-structure, of an adhesive layer, of an external layer or of a spacer layer such as are defined hereinafter.

The expression “comprising a” should be understood as being synonymous with “comprising at least one”, except when specified to the contrary.

1. A method for manufacturing a support integrating at least one electronic device, this support comprising at least one fibrous layer of paper or of non-woven including at least 15% by mass of synthetic fibers, the method comprising:
introducing the electronic device by means of a pick-and-place tool at a cavity-free site of said fibrous layer, by compressing said fibrous layer, in such a way that on completion of this introduction, the electronic device is received in the support without generating any extra thickness.

2. The method as claimed in claim 1, in which the electronic device is chosen from among contactless communication integrated microcircuits, microcircuits with integrated antenna on a chip, resonant microcircuits, micro-transponders and photo-activatable micro-transponders, in particular activated by a laser beam.

3. The method as claimed in claim 1, in which the support comprises at least one adhesive layer covering the fibrous layer.

4. The method as claimed in claim 3, in which the adhesive layer is thermofusible or comprises a pressure-sensitive adhesive.

5. The method as claimed in claim 3, in which the support comprises at least one intermediate layer between the fibrous layer and the adhesive layer.

6. The method as claimed in claim 1, in which the support comprises a printing layer devoid of synthetic fibers.

7. The method as claimed in claim 1, in which the synthetic fibers of the fibrous layer are based on a polyamide and polyester mixture.

8. The method as claimed in claim 1, in which the fibrous layer comprises a bulk latex whose glass transition temperature lies between −40° C. and +60° C.

9. The method as claimed in claim 1, in which the fibrous layer exhibits a compressibility of between 10 and 30%.

10. The method as claimed in claim 1, in which the pick-and-place tool is configured to heat the support and/or the electronic device.

11. The method as claimed in claim 1, comprising the step according to which the off-line or in-line coating of a thermosealing varnish on the one at least of the face of the adhesive layer opposite from the fibrous layer and of the face of the printing layer opposite from the fibrous layer is undertaken.

12. The method as claimed in claim 1, comprising the step according to which the support is cut so as to produce one or more support units of relatively small format, each support unit comprising at least one electronic device.

13. A method for manufacturing a security document comprising a fibrous substrate, comprising introducing one or more support units, of relatively small format, obtained as claimed in claim 12 into a fibrous material dispersion intended to form the fibrous substrate of the security document in a paper machine.

14. A security document such as a passport, an identity card, a driver's license, an interactive playing card or collectible card, a payment means, in particular a payment card, a gift token or a voucher, a transport card, a loyalty card, a benefit card, a subscription card, manufactured by the method as claimed in claim 13.

15. A method for authenticating and/or for identifying a security document comprising a fibrous substrate obtained as claimed in claim 13,
in which a code is assigned to each electronic device of each support unit, the document comprising at least one identifier registered on the document, and in which:
a code is determined, resulting from the association of the codes of the electronic devices of the security document,
said identifier registered on the security document is read, for example visually or automatically,
the identifier of the security document is compared with the resulting code so as to identify and/or authenticate the article.

16. The method of claim 12, the support units being flakes.
